(19) United States
(12) Patent Application Publication
(10) Pub. No.: US 2021/0004851 A1
(43) Pub. Date: Jan. 7, 2021

(54) SYSTEMS AND METHODS FOR CONTROLLING AND INCREASING TRANSPORTATION PLATFORM COMPLIANCE

(71) Applicant: Svanaco, Inc., Des Plaines, IL (US)

(72) Inventors: Norbert Svanascini, Chicago, IL (US); Michael Svanascini, Chicago, IL (US); Chung Chung Tam, Naperville, IL (US)

(21) Appl. No.: 16/920,294

(22) Filed: Jul. 2, 2020

Related U.S. Application Data
(60) Provisional application No. 62/870,619, filed on Jul. 3, 2019.

(51) Int. Cl. G06Q 30/02; G06Q 50/30; G06Q 30/00; G06Q 20/04; G06F 7/58; G07C 9/20

(52) U.S. Cl. CPC G06Q 30/0212; G06Q 50/30; G06Q 30/0185; G06Q 2240/00; G06F 7/588; G07C 9/20; G06Q 20/045

(57) ABSTRACT

A system for increasing compliance with transportation platform requirements includes a communication interface, a memory device, a processing device, and a random element generator. The communication interface receives data representing a plurality of transportation events. Each transportation event is associated with one transportation platform and one user. The memory device stores transportation platform compliant entries based on the data. Each entry corresponds to a single transportation event, and includes a unique identifier linked to the associated user. The random element generator generates random elements. The processing device randomly selects one of the transportation platform compliant entries based on the random elements. The communication interface transmits selection data representative of the randomly selected transportation platform compliant entry for receipt by a notification system, thereby allowing the user linked to the unique identifier of the randomly selected transportation platform compliant entry can be identified and/or announced.

### CROSS-REFERENCE TO RELATED APPLICATION

This application claims the benefit of and priority to U.S. Provisional Patent Application Ser. No. 62/870,619, filed on Jul. 3, 2019, which is hereby incorporated by reference herein in its entirety.

### TECHNICAL FIELD

The present disclosure relates generally to transportation platforms. More particularly, aspects of this disclosure relate to systems and methods for increasing and controlling compliance with transportation platform requirements.

### BACKGROUND

Transportation platforms (such as public transit systems) often face difficulties in collecting the required fares from all users (e.g. riders on the public transit system). User compliance with transportation platform requirements (e.g., users paying the required fares on public transit systems) is dependent on a variety of different factors. Fare evasion by users currently costs transportation platforms significant percentages of the annual fare revenues.

Thus, there is a need for ways to increase user compliance with transportation platform requirements, and to decrease bypassing of the requirements.

### SUMMARY

According to aspects of the present disclosure, a transportation platform compliance system for controlling and increasing user compliance with transportation platform requirements comprises a communication interface, one or more memory devices, a random element generator, and one or more processing devices. The communication interface is configured to receive event data representing a plurality of transportation events. Each of the plurality of transportation events is associated with one of one or more transportation platforms and one of a plurality of users. The one or more memory devices are configured to store a plurality of transportation platform compliant entries based on the received data. Each respective transportation platform compliant entry represents a single one of the plurality of transportation events and includes a unique identifier linked to the associated one of the plurality of users. The random element generator is configured to generate one or more random elements. The one or more processing devices are configured to randomly select one of the plurality of transportation platform compliant entries based at least in part on the one or more random elements, The communication interface is further configured to transmit selection data representative of the unique identifier of the randomly selected transportation platform compliant entry for receipt by a notification system, thereby allowing the associated one of the plurality of users linked to the unique identifier of the randomly selected transportation platform compliant entry to be (i) identified, (ii) announced, or (iii) both (i) and (ii).

According to aspects of the present disclosure, a computer-implemented method for controlling and increasing user compliance with transportation platform requirements comprises: receiving, via a communication interface, event data representing a plurality of transportation events, each of the plurality of transportation events being associated with one of one or more transportation platforms and one of a plurality of users; storing, in one or more memory devices, a plurality of transportation platform compliant entries based on the received event data, each respective transportation platform compliant entry representing a single one of the plurality of transportation events and including a unique identifier linked to the associated one of the plurality of users; generating, via a random element generator, one or more random elements; randomly selecting one of the plurality of transportation platform compliant entries based at least in part on the one or more random elements; and transmitting, via the communication interface, selection data representative of the unique identifier of the randomly selected transportation platform compliant entry for receipt by a notification system, thereby allowing the associated one of the plurality of users linked to the unique identifier of the randomly selected transportation platform compliant entry to be (i) identified, (ii) announced, or (iii) both (i) and (ii).

According to aspects of the present disclosure, a transportation platform compliance system for controlling and increasing user compliance with transportation platform requirements comprises a fare purchasing system, a ticket activation system, and a transportation platform compliant entry selection system. The fare purchasing system is configured to provide tickets to a plurality of users. Each ticket is provided in response to receiving input data representing a corresponding validated payment. The ticket activation system is configured to activate each of the provided tickets prior to corresponding rides on one of one or more transportation platforms by the plurality of users. The ticket activation system is further being configured to generate data representing the activated tickets and the corresponding rides. The transportation platform compliant entry selection system is configured to (i) receive, from the ticket activation system, at least a portion of the generated data representing the activated tickets and the corresponding rides, and (ii) store a plurality of transportation platform compliant entries based on the received data. Each respective transportation platform compliant entry corresponds to a single ride by one of the plurality of users on the one of the one or more transportation platforms using one of the activated tickets. Each respective transportation platform compliant entry includes a unique identifier linked to a corresponding one of the plurality of users. The transportation platform compliant entry selection system is configured to randomly select one of the plurality of transportation platform compliant entries and transmit selection data representative of the unique identifier of the randomly selected transportation platform compliant entry for receipt by a notification system, thereby allowing the corresponding one of the plurality of users associated with the unique identifier of the randomly selected transportation platform compliant entry to be (i) identified, (ii) announced, or (iii) both (i) and (ii).

According to aspects of the present disclosure, a computer-implemented method for increasing and controlling user compliance with transportation platform payment requirements comprises: providing, via a computer-implemented ticket purchasing system, tickets to a plurality of users, each ticket being provided in response to receiving input data representing a corresponding payment; activating, via a computer-implemented ticket activation system, each of the provided tickets prior to corresponding rides on one of one or more transportation platforms to generate data related to the activated tickets and the corresponding rides; transmitting, via a communication interface, at least a portion of the generated data related to the activated tickets and the corresponding rides to a transportation platform compliant entry selection system; storing, in a memory of the transportation platform compliant entry selection system, a plurality of transportation platform compliant entries based on the received data, each respective transportation platform compliant entry corresponding to a single ride by one of the plurality of users on the one of the one or more transportation platform using one of the activated tickets, each respective transportation platform compliant entry including a unique identifier linked to a corresponding one of the plurality of users; randomly selecting one of the plurality of transportation platform compliant entries; transmitting, via a communication interface, selection data representing the unique identifier of the randomly selected transportation platform compliant entry to a notification system; and announcing, via the notification system, an identity of the corresponding one of the plurality of users associated with the unique identifier of the randomly selected transportation platform compliant entry.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1A is an exemplary block diagram of a transportation platform compliance system with a transportation platform compliant entry selection system for increasing and controlling compliance with transportation platform requirements, according to aspects of the present disclosure;

FIG. 1B is an exemplary ticket purchasing system for use with the system of FIG. 1A, according to aspects of the present disclosure;

FIG. 1C is an exemplary ticket activation system for use with the system of FIG. 1A, according to aspects of the present disclosure;

FIG. 1D is an exemplary transportation platform compliant entry selection system for use with the system of FIG. 1A, according to aspects of the present disclosure; and

FIG. 2 is an exemplary method for increasing and controlling compliance with transportation platform requirements within an exemplary transportation platform compliance system, according to aspects of the present disclosure.

FIG. 3 is an exemplary method for increasing and controlling compliance with transportation platform requirements within an exemplary transportation platform compliance system, according to aspects of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

Transportation platforms such as public transit systems often face issues with non-compliant users (e.g., non-compliant riders or passengers). These can be users who gain access to a vehicle of the public transit system without paying for the ride. Non-payment of fares can cost public transit systems thousands and even millions to hundreds of millions of dollars in lost revenues per year depending on the size of the public transit agency.

Non-compliant rides can occur under a variety of different circumstances. For example, a non-compliant user may hop a turnstile or gate located in a station of the public transit system in order to avoid having to scan, read, or otherwise activate a ticket for the ride. Instances of non-compliance can also increase in stations that are not monitored by employees. In other situations, non-compliant users may use free or discounted tickets and/or passes that they generally do not qualify for. This can allow the non-compliant users to gain access to the public transit system for free or for a reduced rate as compared to the normal rate to ride the public transit system. Again, non-monitored stations make it much easier for non-compliant users to use free or reduced-rate tickets for which they do not qualify.

In certain situations, the vehicles of a public transit systems can have multiple doors. Generally, the operator of the vehicle is stationed only near one of the doors, which is the only door intended for users to enter the vehicle at. However, non-compliant transit system users can often board the vehicle by one of the other doors of the vehicle, which are generally intended only for users to exit from. For example, a bus may have both a front door and a back door. Users can exit from either door, but users are only supposed to enter the front door where they can scan their tickets. However, if a transit system user is able to enter the back door of the bus without the operator noticing, the user can ride the bus without having to scan or otherwise present a valid ticket, e.g., without complying with the requirements to validly ride on the bus.

In still other situations, transit system users who promise to pay post-ride do not end up actually paying for rides that have already taken place. For example, if the ticket activation devices used to scan, read, or otherwise validate or activate the transit system user's ticket are broken or otherwise inoperable, the operators of the public transit system may require the transit system user to pay for the ride at a location different from or separate from the transit system vehicle and after the ride is completed. In other situations, transit system users may claim to the operator of the public transit vehicle that the ticket activation devices were inoperable. If the operator does not have a way to confirm the user's claim, the operator may require the user to pay for the ride after the ride is over. However, in either situation, if the operator is unable to confirm whether the transit system user does pay for the ride afterwards, it is easy for transit system users to evade the required post-ride fare payment.

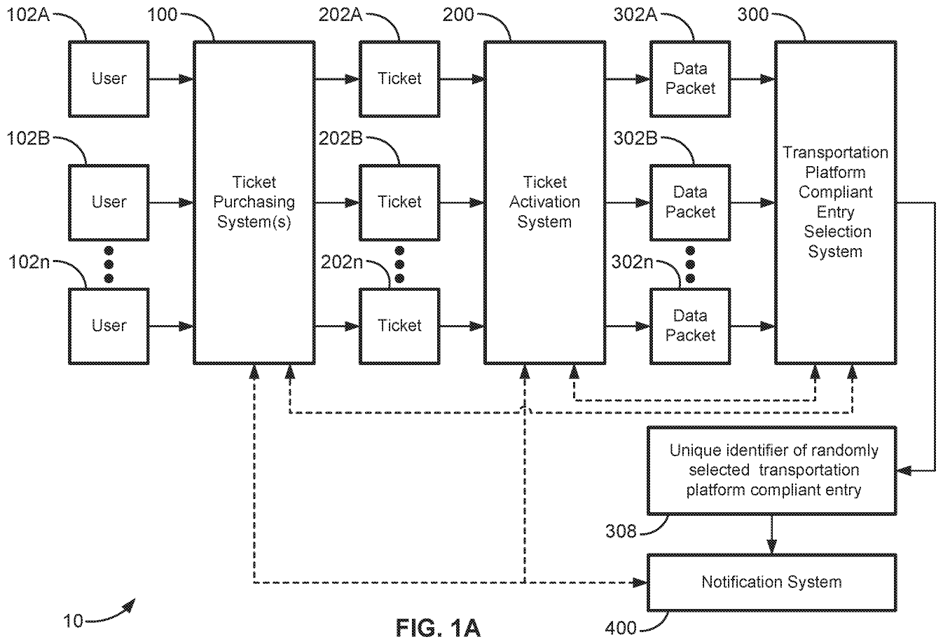

In view of the problem of non-compliant users, FIG. 1A shows a transportation platform compliance system 10 for controlling and increasing, etc. user compliance with transportation platform requirements. The transportation platforms can include traditional public transit platforms, such as a bus network, a subway network, a train network, a trolley network, a tram network, a ferry network, etc. The transportation platforms can also include airlines. The transportation platforms can also include various sharing networks, such as a motor vehicle rideshare network, a non-motor vehicle rideshare network, a motor vehicle share network, a non-motor vehicle share network, etc. The rideshare networks generally include networks where vehicle owners offer rides to users in exchange for payment (e.g., Uber®, LYFT®). The share networks generally include networks where non-owners of the vehicle can rent the vehicle for their own use. Motor vehicle share networks can include automobile share networks (e.g., car rentals, SUV rentals, truck rentals, Zipcar®), motorized bicycle share networks, motorized scooter share networks, motorized personal transportation device share networks (e.g., Segway® rentals), and the like. Non-motor vehicle share networks can include non-motorized bicycle share networks, non-motorized scooter share networks, and the like. In some implementations, one or more of the transportation platforms can be interstate or international/cross-border transportation platforms.

The system 10 is configured to implement a process for randomly selecting a transportation platform compliant entry made into a transportation platform compliance selection system, where each entry is associated with an individual transportation event and an individual user. The transportation event can generally be any desired event related to use of a transportation platform. In one implementation, transportation events can include a user taking a threshold number of rides on one or more of the transportation platforms. The threshold number of rides could be one ride, or multiple rides. The threshold number of rides can also be specific to each individual transportation platform, or can cover multiple transportation events. Generally, each transportation event is associated with one of the transportation platforms and one of the users. However, in other implementations, each transportation event could be associated with two or more transportation platforms, and/or two or more of the users.

Thus, in one example, a user activating a ticket and taking a single ride on a subway system is a transportation event. In another example, a user activating tickets and taking two rides on a subway system is a transportation event. In a further example, a user activating tickets and taking one ride on a subway system and one ride on a bus system is a transportation event.

In additional or alternative implementations, the transportation event can include a threshold amount of money or fares spent on one or more transportation platforms. The threshold amount of money or fares can be split across one or multiple rides. In one example, a single ride on a transportation platform by a user can result in multiple transportation event, if more than the threshold amount of money or fares are spent on a single ride. In another example, a single ride only results in a transportation event if the threshold amount of money or fares is spent, and no additional transportation events are considered to have occurred regardless of how much over the threshold is spent by the user. In yet another example, a transportation event occurs if the money or fares spent on two separate rides on a transportation platform are greater than or equal to the threshold. In these implementations, there can be a time limit between rides, such that money spent on the second ride only counts toward the threshold if the second ride occurs within the time limit from the first ride. The time limit could be, e.g., 30 minutes, 1 hour, 2 hours, 4 hours, 6 hours, 1 day, 2 days, 1 week, 1 month, etc.

The threshold amount of money or fares can also be split across one or multiple transportation platforms. In one example, a transportation event occurs when a user spends half of the threshold amount of money or fares on a ride on a first transportation platform, and half of the threshold amount of money or fares on a ride on a second transportation platform. Similar to the above example, there can be a time limit, such that money spent on the ride on the second transportation platform only counts toward the threshold if it occurs within the time limit from the ride on the first transportation platform. Thus, in one example, a user spending a specified amount of money on a ride via a vehicle ride network is a transportation event.

Generally, data representing one or more transportation events can be used to generate transportation platform compliant entries. A randomly selected entry can be from among a significant number of entries that are each associated with a paid-fare transit system user (e.g., a transit system user that pays the required fare or uses a ticket or pass that was validly purchased) of the one or more public transit systems, and/or a user of other transportation platforms. For example, when a paid-fare user of a public transit system rides on one of the one or more public transit systems, an entry into the transportation platform compliance selection system will be generated that is associated with the user's paid fare upon the user's paid ticket being activated prior to the ride. In another example, when a user utilizes other transportation platforms such as vehicle rideshare networks or vehicle share networks, an entry into the transportation platform compliance entry selection system will be generated. Non-compliant users of the transportation platforms (e.g., users who jump a turnstile or otherwise fail to activate a ticket prior to riding) are not entered into the transportation platform compliance selection system. Thus, the transportation events occur when a user takes a ride or spends a threshold amount of money or fares on a transportation platform, in compliance with that transportation platform's requirements (which could be related to validated fare payments and/or other requirements). The entries into the compliance system are thus referred to as transportation platform compliant entries.

As such, by complying with transportation platform requirements (e.g., paying for a ride, using a validly obtained ticket for a ride, using a valid account to pay for a vehicle rideshare or a vehicle share), transportation platform users are entered into the compliance selection system. Users who ride the transportation platforms but do not comply with the requirements (e.g. users who hop turnstiles) are not entered into the compliance selection system.

The system 10 controls and increases compliance with fare payment requirements and other transportation platform requirements, and thereby increases fare collections from transportation platform users.

In some aspects, the system 10 includes a ticket purchasing system 100, a ticket activation system 200, a transportation platform compliant entry selection system 300, and a notification system 400. The ticket purchasing system 100 is configured to provide tickets to users of the public transit system. For example, as shown in FIG. 1A, users 102A, 102B . . . 102n, can purchase tickets 202A, 202B . . . 202n using the ticket purchasing system 100. User 102A uses the ticket purchasing system 100 to purchase ticket 202A. User 102B uses the ticket purchasing system 100 to purchase ticket 202B. User 102n uses the ticket purchasing system 100 to purchase ticket 202n.

The ticket purchasing system 100 can generally be configured to provide any type of ticket to a user. For example, users can purchase single-ride tickets, multi-ride tickets, unlimited-use passes (daily, weekly, monthly, yearly, etc.). The ticket purchasing system 100 can be configured to provide physical tickets (such as paper tickets, plastic tickets, etc.), electronic tickets, or any other suitable type of ticket. The electronic tickets could be located on a mobile device (such as a cell phone or tablet), a smart card, a contactless bankcard, an NFC-enabled card or device, a mobile wallet, etc. In some implementations, system 10 includes multiple separate ticket purchasing systems 100 that provide tickets for different public transit systems. For example, system 10 may include a first ticket purchasing system 100 for a subway system, and a second ticket purchasing system 100 for a bus system. In other implementations, the ticket purchasing system 100 includes a plurality of individual sub-systems that each provide tickets for a different public transit system. In still other implementations, a single ticket purchasing system 100 provide tickets for multiple types of public transit systems, for example both a subway system and a bus system. In any implementations, the transportation platform purchasing system 100 provides tickets in response to receiving some type of input indicative of a corresponding validated payment made by the transit system user.

As shown in FIG. 1B, the ticket purchasing system 100 can have generally any physical form and can include a number of different types of sub-units or sub-systems. For example, the ticket purchasing system 100 can include one or more ticket purchasing kiosks 104A, one or more portable ticket purchasing devices 104B, and a ticket purchasing network 104C. The ticket purchasing kiosks 104A can be placed, for example, in subway or train stations, and are generally stationary. Users can use the ticket purchasing kiosks 104A to purchase any desired ticket. The ticket purchasing kiosks 104A may also include devices with a smaller form factor that are installed on other types of public transit systems, such as buses or car services. The ticket purchasing kiosks 104A could also be located in other locations, such as drug stores, convenience stores, gas stations, super markets, other third party retail outlets, etc.

The portable ticket purchasing devices 104B can be any device that can be carried around by transit system employees and allow for the purchase of tickets by transit system users. For example, train or subway conductors and/or employees may carry a portable ticket purchasing device 104B to allow transit system users to purchase a ticket after they have boarded the vehicle (e.g., the train or subway car). The portable ticket purchasing devices 104B could be electronic devices that transmit electronic tickets to users, electronic devices that print physical tickets for users, or simply a bundle of physical tickets, from which an employee can provide tickets to users. Finally, the ticket purchasing network 104C can be any online system that allows transit system users to access and purchase tickets. For example, the ticket purchasing network 104C can be a website or server that users can navigate to with a network-connected web browser or mobile app using any suitable computing device, such as a mobile phone or laptop computer. Once the transit system user has navigated to the website or server via a web browser or mobile app, they can purchase any desired type of ticket that is available for purchase.

In some implementations, the ticket purchasing system 100 includes any devices or networks needed for users to purchase rides on transportation platforms that do not require actual tickets. For example, the ticket purchasing network 104C can include a website or server that users navigate to in order to activate and pay for rides on a vehicle rideshare network, a website or server that users navigate to in order to rent a vehicle through a vehicle share network, etc. In other examples, the ticket purchasing kiosks 104A and the portable ticket purchasing devices 104B can also include devices used to purchase rides on transportation platforms that do not require tickets. Thus, the ticket purchasing system 100 can generally include any devices, networks, infrastructure, etc. needed for users to purchase tickets for rides on transportation platforms requiring tickets (such as traditional public transit systems like buses and subways); and can generally also include any devices, networks, infrastructure, etc. needed for users to pay for rides on vehicle rideshare networks and/or for vehicles on vehicles share networks.

Referring back to FIG. 1A, the ticket activation system 200 is configured to activate individual tickets prior to the user boarding the public transit system. Generally, the ticket activation system 200 will scan, read, or otherwise confirm that the transit system user possesses a ticket or pass that was validly purchased, in order to allow them to board the public transit system. In some implementations, the users themselves may activate their own tickets (for example if they have an electronic ticket or pass on their phone), and the ticket activation system 200 verifies that the user has activated a valid ticket. Thus, in exemplary transportation platform compliance system 10, the ticket activation system 200 will activate user 102A's ticket 202A, user 102B's ticket 202B, and user 102n's ticket 202n.

Generally, tickets will be activated a short time period prior to the ride itself. For example, on a subway system, tickets are activated (e.g. read or scanned by turnstiles) at most about fifteen minutes before the user boards the subway vehicle. However, the tickets can be activated generally at any point in time prior to a subsequent ride on a transit system.

Similar to the ticket purchasing system 100, the ticket activation system 200 can include a number of sub-units or sub-systems including varying combinations thereof. For example, FIG. 1C shows that the ticket activation system 200 can include one or more stationary ticket readers 204A, one or more portable ticket readers 204B, and/or one or more manual ticket readers 204C. The stationary ticket readers 204A, similar to the ticket purchasing kiosks 104A, are generally placed permanently or semi-permanently near the entrance to a public transit system. For example, in a subway or train station, the stationary ticket reader 204A can take the form of a turnstile that reads the user's purchased ticket and activates the ticket for that ride. On a bus, the stationary ticket reader 204A can be smaller ticket reader that requires the transit system user to scan a purchased ticket before boarding and/or walking to a seat on the bus.

The stationary ticket readers 204A can activate the transit system user's tickets in a variety of different ways. For example, if the ticket is a physical ticket (e.g. a paper ticket, a card, etc.), the stationary ticket reader 204A may activate the ticket via a Quick Response (QR) code, near-field communication (NFC), magnet stripe reader, bar code, etc. If the ticket is an electronic ticket and is located on the user's mobile phone or other electronic device, the stationary ticket reader 204A can communicate or otherwise interface with the mobile phone to activate the ticket for a ride. In other implementations, the stationary ticket reader 204A could scan or otherwise capture an image on the display of the mobile phone. In still other implementations, the users may activate their own tickets first (e.g., activating an electronic ticket stored on their phone), and the stationary ticket readers 204A can verify that the user has activated a valid ticket.

The portable ticket readers 204B are similar to the stationary ticket readers 204A, except that the portable ticket readers 204B can generally be carried around by employees of the public transit system. For example, a conductor or other employee on a public transit system may have a handheld device that scans tickets presented by transit system users. In still other implementations, the users may activate their own tickets first (e.g., activating an electronic ticket stored on their phone), and the portable ticket readers 204B can verify that the user has activated a valid ticket.

The manual ticket readers 204C are generally any manual mechanism or method used to activate the user's ticket. For example, a conductor or other employee of the public transit system may walk around to view user's tickets in order to “activate” the user's ticket for that ride. This activation can take a variety of forms, such as the conductor physically marking or modifying the ticket, making a notation in a record book, etc., and manually entering a unique identifier from the transit system user's ticket into a device (such as a portable ticket reader 204B) via a user interface, such as a keypad. In some implementations, all of the ticket readers 204A, 204B, and 204C can be configured to activate both physical tickets and electronic tickets. Further, in some implementations, all of the ticked readers 204A, 204B, and 204C can be configured to activate single-ride tickets, multi-ride tickets, or unlimited-use passes for individual rides by a transit system user on a public transit system. In still other implementations, the users may activate their own tickets first (e.g., activating an electronic ticket stored on their phone), and the manual ticket readers 204C can verify that the user has activated a valid ticket.

The stationary ticket readers 204A and the portable ticket readers 204B can be non-contact or non-insertion readers such as NFC-enabled devices, scanners, imagers, etc. These types of readers can activate user's ticket without the transit system user or employee having to insert the ticket into the reader. The stationary ticket readers 204A and the portable ticket readers 204B could also be insertion readers, e.g., the user is required to feed their ticket into the readers 204A or 204B so as to activate their ticket for the ride. In some implementations, various sub-units of the ticket purchasing system 100 and the ticket activation system 200 can be combined. For example, a single device can both provide tickets to a transit system user and activate a user's ticket for a ride.

As shown in FIG. 1C, the ticket activation system 200 can also include one or more communication interfaces 206, one or more memory devices 208 coupled to the communication interfaces 206, and one or more processing devices 210 coupled to the memory devices 208. Ticket readers such as stationary ticket readers 204A and portable ticket readers 204B can be communicatively coupled to the communication interfaces 206 so as to transmit data regarding ride activations to the communication interfaces 206 and store the data in the memory devices 208. The ticket readers 204A, 204B can be communicatively coupled to the communication interfaces 206 using any suitable mechanisms, including wired and wireless connection, networked connections, etc. and the transmission of data can occur in real-time or periodically.

Any data from the manual ticket readers 204C (e.g., human conductors that activate tickets for rides) must generally be manually input into the memory devices 208 of the ticket activation system 200. Thus, the ticket activation system 200 may also include one or more user interfaces 212 that allow this data to be manually entered. The communication interfaces 206 of the ticket activation system 200 can also be communicatively coupled to the transportation platform compliant entry selection system 300.

As noted herein, in some implementations, users can activate their own tickets first, and the ticket activation system 200 can then verify that the user has activated a valid ticket. In some of these implementations, instead of a reader verifying that the user has activated a valid ticket, the ticket activation system 200 can include one or more networks that receives data indicating that users have activated their own tickets using their own private devices (such as mobile phones, tablets, computers, etc.). These networks can also receive data indicating that the user has purchased or otherwise activated a ride on a transportation platform not requiring a ticket (e.g., a vehicle rideshare network or a vehicle share network). The user's device can communicate remotely (e.g., via the Internet) with the network to indicate that the user's ticket has been activated, or to indicate that the user has paid for or activated a ride on vehicle rideshare network or a vehicle share network. In some implementations, at least some of these networks can transmit data regarding activated tickets and/or confirmed rides to the communication interfaces 206 and store this data in the memory devices 208. In additional or alternative implementations, at least some of these networks are implemented using some combination of the communication interfaces 206, the memory devices 208, the processing devices 210, and the user interfaces 212.

Referring back to FIG. 1A, after the ticket activation system 200 activates tickets 202A, 202B . . . 202n for a ride and/or confirms a user's validated payment or activation of a ride using a vehicle rideshare network or vehicle share network, data packets 302A, 302B . . . 302n can be sent from the ticket activation system 200 (e.g., via communication interface 206) to the transportation platform compliant entry selection system 300. The data packets 302A, 302B . . . 302n include data that is used to form the transportation platform compliant entries from which a random selection is then made by the transportation platform compliant entry selection system 300, to allow for issuance of an incentive to the transit system user associated with the selected compliant entry.

The transportation platform compliant entry selection system 300 is shown in FIG. 1D, and can include one or more communication interfaces 303 (e.g., communicatively connected to the ticket activation system 200), one or more memory devices 304, and one or more processing devices 306. The one or more memory devices 304 can form a database that stores all of the individual data packets 302A, 302B . . . 302n. The communication interface 303 of the transportation platform compliant entry selection system 300 receives the data packets 302A, 302B . . . 302n from the ticket activation system 200 and stores the data packets 302A, 302B . . . 302n in a database formed in the memory devices 304. The one or more processing devices 306 of the transportation platform compliant entry selection system 300 can analyze the transportation platform compliant entries and randomly select the winning transportation platform compliant entry. In some implementations, the transit platform compliant entry selection system 300 can communicate to users (for example, via the users' mobile devices) that an entry for their transportation event has been generated.

The data packets 302A, 302B . . . 302n can be the individual transportation platform compliant entries themselves formed within the ticket activation system or some intermediary system between the ticket activation system 200 and the transportation platform compliant entry selection system 300, or can include all required information for the transportation platform compliant entry selection system 300 to create and store the individual transportation platform compliant entries into the database that is analyzed for the random selection of a winning transportation platform compliant entry. In some implementations, the entries are in the form of a number that is stored in a location within the transportation platform compliant entry selection system 300 that is identifiable to a transit system user somewhere within the system 10 or another communicatively connected third-party system.

The ticket activation system 200 can send the data packets 302A, 302B . . . 302n to the transportation platform compliant entry selection system 300 using any suitable mechanism. For example, the transportation platform compliant entry selection system 300 can be accessed via a web-accessible application. The ticket activation system 200 can also communicate with the transportation platform compliant entry selection system 300 using transmitters or other communication mechanisms for transferring data from one system to another.

Each of the data packets 302A, 302B . . . 302n generally include a unique identifier that is linked to an individual transit system user, which allows the identity of user to be determined. After the transportation platform compliant entry selection system 300 has received all of the data packets 302A, 302B . . . 302n and stored all of the transportation platform compliant entries, the transportation platform compliant entry selection system 300 can randomly select one of the transportation platform compliant entries as a winning entry. The transportation platform compliant entry selection system 300 can then transmit selection data to the notification system 400 via the communication interfaces 303. The selection data is representative of the unique identifier of the randomly selected transportation platform compliant entry and/or the identity of the transit system user linked to the randomly selected transportation platform compliant entry. The notification system 400 can identify and announce the identity of the transit system user whose entry was randomly selected.

In some implementations, each data packet 302A, 302B . . . 302n sent to the transportation platform compliant entry selection system 300 is generally considered to be a transportation platform compliant entry linked to a single transportation event experienced by a single transportation platform user. The data packets 302A, 302B . . . 302n can be sent to the transportation platform compliant entry selection system 300 in real-time, or on a regular periodic schedule. For example, the ticket activation system 200 can transmit the data packets 302A, 302B . . . 302n to the transportation platform compliant entry selection system 300 as the data packets 302A, 302B . . . 302n are created (e.g., every time a transportation event occurs, such as when a transit system user activates a paid ticket). In another example, the ticket activation system 200 transmits the data packets 302A, 302B . . . 302n at the end of a predetermined period (e.g., every day, week, month, etc.).

Generally, every transportation event has one or more characteristics. The data packets 302A, 302B . . . 302n can include data representative of the values of these characteristics for each transportation event. These characteristics can include the type of transportation platform associated with the transportation event (e.g., bus, subway, train, vehicle rideshare, vehicle share, etc.), the type of ticket associated with the transportation event (e.g., single-use ticket, multi-use ticket, unlimited-use pass, physical ticket/pass, electronic ticket/pass etc.), the type of payment associated with the transportation event (e.g., cash, credit card, etc.) the identity of a route associated with the transportation event, the time of day the transportation event occurred (which could include one or both of the beginning time and the ending time), the distance traveled during the transportation event, the temporal duration of the transportation event (e.g., how long the transportation event lasted, the age of the user associated with the transportation event (which could be a numerical age, a numerical age range, an age category such as child, adult, senior, student, etc.), a physical status of the user associated with the transportation event (e.g., disabled), or any combination thereof. The data packets 302A, 302B . . . 302n can also include data related to the purchase of the tickets used for the transportation events, such as where the tickets were purchased and how the tickets were paid for.

In implementations where the data packets 302A, 302B . . . 302n are individual transportation platform compliant entries in a condition for or near ready for random selection by the transportation platform compliant entry selection system 300, the data packets 302A, 302B . . . 302n generally include at least the unique identifier that links an individual transportation platform compliant entry to a specific transportation event, and thus a specific transportation platform and a specific user. The data packets 302A, 302B . . . 302n can also include data about the characteristics of the transportation event (e.g., values of the characteristics), which can include one or more of the characteristics discussed herein. In this implementation, the transportation platform compliant entry selection system 300 simply stores the individual transportation platform compliant entries into the database after receiving them from the ticket activation system 200, and then selects the winning transportation platform compliant entry from all of the stored transportation platform compliant entries.

In other implementations, the data packets 302A, 302B . . . 302n are not individual transportation platform compliant entries, but instead include all or at least a portion of the information related to the transportation events that is necessary for the transportation platform compliant entry selection system 300 to create and store the individual transportation platform compliant entries. For example, each data packet 302A, 302B . . . 302n could include a unique identifier for one user, and data about all of the transportation events experienced by that user within a certain time period. The transportation platform compliant entry selection system 300 then analyzes each data packet 302A, 302B . . . 302n to create the transportation platform compliant entries for that individual user. For example, if data packet 302A indicates that user 102A experienced ten individual transportation events within the set time period, the transportation platform compliant entry selection system 300 can create and store ten individual transportation platform compliant entries in the database of the transportation platform compliant entry selection system 300. Thus, when the transportation platform compliant entry selection system 300 randomly selects the winning transportation platform compliant entry, that user will have ten transportation platform compliant entries in the database that could potentially be selected as the winning transportation platform compliant entry.

In another example of these implementations, each data packet 302A, 302B . . . 302n contains all or at least all necessary information for creating transportation platform compliant entries related to a single transportation event (which could be a single ticket that was activated for a ride on a transportation platform, whether the ticket was a single-ride ticket, a multi-ride ticket, or an unlimited-use pass; a threshold number of tickets activated for a ride on a transportation platform; a threshold amount of money or fares spent on a transportation platform, etc.). In these implementations, the transportation platform compliant entry selection system 300 analyzes the data packets 302A, 302B . . . 302n to determine how many transportation platform compliant entries need to be created from each data packet 302A, 302B . . . 302n. For example, upon determining that data packet 302A contains information related to the activation of a single-ride ticket, the transportation platform compliant entry selection system 300 can create a single transportation platform compliant entry and store that transportation platform compliant entry in the database. In another example, if the data packet 302B contains information related to the use of a multi-ride pass, the transportation platform compliant entry selection system 300 must determine how many of the rides on the multi-ride pass were used, and create a corresponding number of transportation platform compliant entries. In a further example, if the data packet 302n contains information about the use of an unlimited-use pass, the transportation platform compliant entry selection system 300 determines how many rides were activated from the unlimited-use pass in the time period and creates that many individual transportation platform compliant entries. In some implementations, the transportation platform compliant entry selection system 300 may limit the number of entries a single user can receive during a time period, regardless of how many transportation events are associated with that user during the time period. This can discourage users from attempting to fool the selection system 300, for example by repeatedly activating an unlimited-use pass at a ticket activation device.

In other implementations, the data packets 302A, 302B . . . 302n have different formats. Generally, any format for the data packets 302A, 302B . . . 302n can be used, so long as the transportation platform compliant entry selection system 300 can analyze the data packets 302A, 302B . . . 302n and create and store individual transportation platform compliant entries. In some implementations, the transportation platform compliant entries may be associated with one or more transportation events experienced by one or more users. Each transportation platform compliant entry can thus be associated with one or more users taking one or more rides on one or more transportation platforms, and/or one or more users spending a threshold amount of money or fares for one or more rides on one or more transportation platforms.

In any of the implementations, the data packets 302A, 302B . . . 302n contain a unique identifier that is linked to an individual user. When the transportation platform compliant entry selection system 300 randomly selects the winning transportation platform compliant entry, the unique identifier 308 of the randomly selected transportation platform compliant entry can be transmitted to the notification system 400, which is configured determine and/or announce the identity of the transit system user associated with the transmitted unique identifier.

In some implementations, the unique identifier of each transportation platform compliant entry is simply the user's name. In these implementations, any data packet linked to a ride that the user took will have the same unique identifier, e.g., will have the user's name. In these implementations, when the transportation platform compliant entry selection system 300 transmits the unique identifier 308 of the randomly selected transportation platform compliant entry to the notification system 400, the transportation platform compliant entry selection system 300 is effectively also transmitting the name/identity of the winning transit system user to the notification system 400.

In other implementations, the unique identifier of each transportation platform compliant entry may be an ID number, passcode, phone number, nickname, alias, email address, username, a residential address, a mailing address, or other identifier that obscures the identity of the transit system user from the transportation platform compliant entry selection system 300. These implementations can be used when it is desirable to keep the transit system user's names hidden from the transportation platform compliant entry selection system 300. In these implementations, after the transportation platform compliant entry selection system 300 randomly selects the winning transportation platform compliant entry, the transportation platform compliant entry selection system 300 transmits only the corresponding unique identifier 308 to the notification system 400, as the transportation platform compliant entry selection system 300 does not know the actual identity of the transportation platform user associated with the randomly selected transportation platform compliant entry. In these implementations, the notification system 400 can link the unique identifier to the transportation platform user's name, and then announce the identity of the transportation platform user associated with the randomly selected transportation platform compliant entry. A single user can have the same unique identifier for each transportation platform compliant entry, such that multiple locations within the database (e.g., multiple stored transportation platform compliant entries) all contain the same identifier. Or, each transportation platform compliant entry can contain a distinct unique identifier, such that a single user may have multiple unique identifiers stored in the database of the transportation platform compliant entry selection system 300 that are linked to them. In either example, the notification system 400 is able to link the unique identifier of the winning transportation platform compliant entry to the identity of that transit system user.

In some implementations, the ticket purchasing system 100 may also send one or more data packets to the transportation platform compliant entry selection system 300. Generally, it is contemplated that any data packets sent to the transportation platform compliant entry selection system 300 from the ticket purchasing system 100 would include purchasing data related to ticket purchases. These data packets can be used to create additional transportation platform compliant entries for the selection process of a transportation platform compliant entry, or can be used in conjunction with data packets 302A, 302B . . . 302n to create the transportation platform compliant entries.

In certain situations, the ticket activation system 200 may not be able to obtain data related to all tickets or passes that are activated for a ride. If a transit system user has a physical ticket that lacks any type of electronic communication mechanism, the ticket activation system 200 may not be able capture and transmit data related to the ride that the ticket is activated for. For example, a transit system user may have a ticket that the public transit employee marks or otherwise acknowledges is valid for a ride. However, there is generally no electronic data to capture and transmit to the transportation platform compliant entry selection system 300. If the data is not entered manually into the ticket activation system via the user interface(s) 212, the user will not receive a transportation platform compliant entry corresponding to the ride, even though the user complied with the fare payment requirements. For these situations, it is contemplated that certain implementations allow for the transportation platform compliant entry selection system 300 to use the purchasing data received from the ticket purchasing system 100 to estimate compliant rides taken where no electronic data could be captured and transmitted by the ticket activation system 200.

The data packets sent by the ticket purchasing system 100 can be the same or similar to the data packets 302A, 302B . . . 302n, e.g., include data about individual ticket/pass purchases and/or purchases related to transportation platforms that do not use tickets/passes, all data about purchases by a single user within a certain period, etc. Generally, the transportation platform compliant entry selection system 300 analyzes the purchasing data received from the ticket purchasing system 100 to estimate a number of additional transportation platform compliant entries needed for the selection of a winning transportation platform compliant entry. Thus, users who utilize physical tickets with no electronic communication mechanism can still receive entries for these rides. The data from the ticket purchasing system 100 can also be used to double-check the transportation platform compliant entries received in or created from data packets 302A, 302B . . . 302n from the ticket activation system 200.

The one or more memory devices 304 contain processor-executable instructions that, when executed by the one or more processing devices 306 of the transportation platform compliant entry selection system 300, cause the one or more processing devices 306 of the transportation platform compliant entry selection system 300 to randomly select one of the transportation platform compliant entries stored in the database. The transportation platform compliant entry selection system 300 can execute any suitable random selection algorithm.

In one example, the transportation platform compliant entry selection system 300 includes a random element generator 310. The random element generator 310 is used to generate one or more random elements (such as numbers, letters, symbols, phrases, etc.), and the random selection of the transportation platform compliant entry is based at least on these random elements. In this example, each transportation platform compliant entry is assigned a number according to its position in the database of the transportation platform compliant entry selection system 300. The random element generator 310 can then be used to generate a random number. The transportation platform compliant entry located at the database position randomly generated number is selected as the winning transportation platform compliant entry. In these implementations, the random element generator 310 could be a pseudo-random number generator implemented as software, e.g., the instructions or programming for the pseudo-random number generator are stored on the one or more memory devices 304 of the transportation platform compliant entry selection system 300 and executed by the processing devices 306 of the transportation platform compliant entry selection system 300. In other implementations, the random element generator 310 is a physical random number generator (also known as a hardware random number generator or a true random number generator) implemented by a device separate from the memory devices 304 and the processing devices 306. Other random selection algorithms can also be used.

In some implementations, the transportation platform compliant entry selection system 300 has defined secure interfaces or application specific programming interfaces (API's) to connect to the ticket purchasing system 100. The data packets 302A, 302B . . . 302n can include data representing any of the characteristics of the transportation events, such as user account number, ticket number, date and time of ride, categories of rider that the rider falls into, etc. The transportation platform compliant entry selection system 300 can send an acknowledgement to one or both of the ticket purchasing system 100 and the ticket activation system 200 (or other systems or entities) sometime after receiving or upon receipt of the data packets 302A, 302B . . . 302n. Generally, it is contemplated that the data packets 302A, 302B . . . 302n can be encrypted and securely stored in the transportation platform compliant entry selection system 300 to prevent fraud. The transportation platform compliant entry selection system 300 can also have restricted access control and monitoring to prevent unauthorized access and data manipulation. In some implementations, some number of the transportation platform compliant entries can be audited, for example via a security algorithm running on the transportation platform compliant entry selection system 300.

The transportation platform compliant entry selection system 300 can store different transportation platform compliant entries in different repositories based on a variety of different properties or characteristics (e.g., selection rules, selection eligibility). The repositories can be located on one or more of the memory devices 304. For example, all entries based on transportation events experienced by students may be put into a single repository within the transportation platform compliant entry selection system 300, and the transportation platform compliant entry selection system 300 can randomly select only one of these student entries within this one repository. The transportation platform compliant entry selection system 300 can have a separate repository for other classes of entries, such as entries from adults, seniors, disabled users, etc. The ultimate prize awarded to the user associated with the randomly selected transportation platform compliant entry can be based on the specific repository from which that entry was selected. For example, the user associated with the randomly selected entry from a student repository may be awarded a scholarship, while the user associated with the randomly selected entry from an adult or non-student repository may be awarded a monetary prize.

The randomly selected entry (or data associated with the randomly selected entry) can, in some implementations, be stored separately in the transportation platform compliant entry selection system 300 after it has been randomly selected, prior to being transmitted to the notification system 400 or other system.

In some implementations, the random selection algorithm can weight the individual transportation platform compliant entries based on the values of the characteristics of the associated transportation event. As noted herein, every transportation event has a variety of different characteristics, including, for example, the type of transportation platform associated with the event (e.g., subway, bus, train, tram, car, light rail, elevated rail), the type of ticket used for the transportation event (e.g., physical, electronic, single-ride, multi-ride, unlimited-use), etc. An owner, operator, or participant in the transportation platform compliance system 10 or of any of the transportation platforms may want to incentivize certain rides having certain predetermined desired values of any one or more of the characteristics. To accomplish this, the transportation platform compliant entry selection system 300 can weight more heavily transportation platform compliant entries that are linked to transportation events having the desired values of a characteristic of interest.

Desirable transportation events (e.g., transportation events having desired values of a characteristic of interest) can be weighted to increasing the likelihood that entries associated with desirable transportation events are randomly selected in a variety of different ways. In some implementations, this weighting includes storing multiple transportation platform compliant entries in the database of the transportation platform compliant entry selection system 300 for these desirable transportation events, thus making it more likely that the random selection algorithm will randomly select a transportation platform compliant entry associated with a desirable transportation event. In additional or alternative implementations, some or all of the entries associated with undesirable transportation events (e.g., transportation events not having the desired value of the characteristic of interest) can be discarded, which also makes it more likely that the random selection algorithm will randomly select entries associated with desirable transportation events. Generally, any suitable techniques can be used to weight more heavily entries associated with desirable transportation events, and weight less heavily entries associated with undesirable transportation events.

In some implementations, rides taken using paper/physical tickets do not result in a transportation platform compliant entry being generated and stored in the transportation platform compliant entry selection system 300, so as to prompt riders to use electronic tickets, which are generally more secure than paper/physical tickets. In other implementations, the owner or operator of a public transit system may wish to encourage users to use multi-ride tickets or unlimited-use passes. To accomplish this, the transportation platform compliant entry selection system 300, when analyzing the data packets 302A, 302B . . . 302n received from the ticket activation system 200, can create multiple transportation platform compliant entries for any ride on the public transit system that utilized a multi-ride ticket or any type of unlimited pass. Thus, when the transportation platform compliant entry selection system 300 randomly selects one of the transportation platform compliant entries, transportation platform compliant entries associated with multi-ride tickets or unlimited-use passes have a higher chance of being selected. This encourages users to use multi-ride tickets or unlimited-use passes.

In still other implementations, the transportation platform compliant entries can be filtered prior to the random selection, so that only entries within pre-defined categories can be selected. In some of these implementations, entries associated with desirable transportation events can be stored in their own repository, and the random selection algorithm can operate on only this repository. In others of these implementations, entries associated with undesirable transportation events can be discarded/deleted, so that the random selection algorithm only operates on the entries associated with the desirable transportation events. Thus, these filtering operations can be used to operate a random selection of entries corresponding to, for example, only senior citizens, or only students. In some implementations, these filtering operations can be used to operate multiple random selections over a single time period. For example, separate random selections can be performed for senior citizens, students, and non-senior adults, so that an entry from each category can be selected.

In still other implementations, entries associated with undesirable transportation events are simply never generated. Thus, in these implementations, the repositories in the memory devices 304 only store entries associated with desirable transportation events. Thus, in these implementations, the random selection algorithm only selects from entries associated with desirable transportation events.

In one example, weighting and/or filtering can be used to target a specific class or type of user. In this example, entries associated with a specific class of user can be weighted more heavily, and/or entries not associated with the specific class of user can be discarded. For example, entries associated with senior citizens and/or students could be weighted more heavily than entries associated with non-senior adults, to incentivize senior citizens and/or students to use the various transportation platforms. Alternatively, entries associated with non-senior adults could be filtered out of the repository so that the non-senior adult entries cannot be selected.

In another example, weighting and/or filtering can be used to narrow the time frame for transportation events eligible to be selected. The entries can be filtered so that selections are performed daily, weekly, monthly, etc. Entries corresponding to desired time periods can be weighted more heavily, and/or entries corresponding to undesired time periods can be discarded. In one example, entries representing events occurring at off-peak times (e.g., between 10 AM and 3 PM to avoid rush hour) can be weighted more heavily and/or maintained in the repositories, to promote off-peak riding.

In still another example, users may be able to opt-in to certain features that make their entries eligible to be selected and/or more likely to be selected. The user could opt in to any combination of providing their location (e.g., via their phone's GPS), providing demographic data, accepting advertising (e.g., in a mobile application), accepting notifications (e.g., from a mobile application), or other services.

In certain implementations, the notification system 400 receives the unique identifier of the selected transportation platform compliant entry and/or the identity of user associated with the selected transportation platform compliant entry. The notification system 400 can announce the winning user by any suitable mechanism, such as via television or radio broadcast, an email, a text message, a phone call, a social media post, a transportation platform-specific mobile application, billboards, a dedicated display device, a post on an online website, kiosks or other displays at transportation platform stations, (such as rail station kiosks, bus stop displays/ads, terminal displays, on-board displays,) or any other suitable mechanism or method. The notification system 400 may also announce the user or another unique identifier associated with the winning transportation platform compliant entry using multiple different methods. In some implementations, the notification system 400 is a distributed network of a plurality of different ways of notifying the user associated with the randomly selected entry. Any data communicated from the transportation platform compliant entry selection system 300 and announced by the notification system 400 can include information on when and where the user associated with randomly selected entry can claim or collect their prize.

In implementations where the transportation platform compliant entry selection system 300 sends the identity of the associated winning user to the notification system 400, the notification system 400 can simply announce the identity of the winning user (e.g., can announce the winning user's name). However, in implementations where the transportation platform compliant entry selection system 300 either does not know the names/identities of the users or does not send that information to the notification system 400, the notification system 400 must link the unique identifier that the transportation platform compliant entry selection system 300 will send with the identity of the winning user. Thus, in these implementations, the notification system 400 can be linked to one or both of the ticket purchasing system 100 and the ticket activation system 200. Via this link, the notification system 400 can be permitted to determine the identity of the user corresponding to the unique identifier the notification system 400 receives from the transportation platform compliant entry selection system 300.

The transportation platform compliant entry selection system 300 can be configured to operate on any desired predetermined timeframe. For example, the transportation platform compliant entry selection system 300 may conduct a daily, business-weekly (e.g., 5 days), calendar-weekly (e.g., 7 days), a monthly, yearly, etc. random selection of compliant entry, etc. The transportation platform compliant entry selection system 300 may also conduct selections of compliant entries on overlapping time frames, such as individual selection of compliant entries for each of multiple weeks and a single selection of compliant entries for an entire month including those multiple weeks. The transportation platform compliant entry selection system 300 could also operate special selections of compliant entries on specific dates. Further, the selected compliant entry can provide for an award of any suitable prize to the winning user associated with the selected entry. For example, the winning user could receive a monetary award, free or reduced tickets or passes, tickets to sporting events, scholarships, meetings with celebrities, or any other tangible or intangible prize. The prize could also be in the form of accumulated points, which can then be redeemed in the future for various prizes. However, users' compliant use of the various transportation platforms and associated entry into the transportation platform compliant entry selection system 300 does not accrue any value attributable to the user other than a random chance to have their associated entry selected.

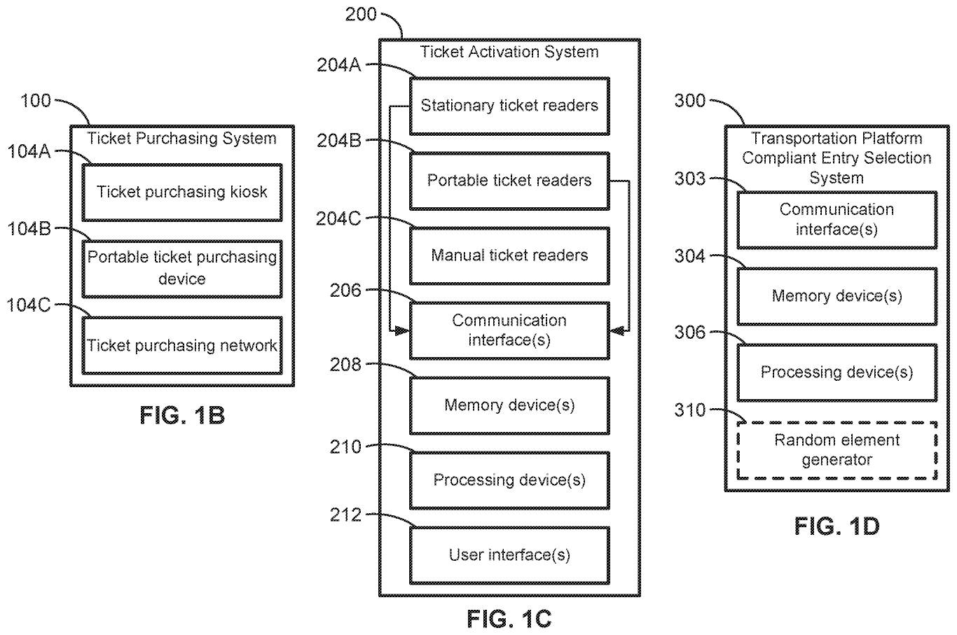

Referring now to FIG. 2, a method 401 (which is computer-implemented in some implementations) for controlling and increasing user compliance with transportation platform requirements is illustrated. At step 402, tickets (or passes) are provided to transit system users of one or more transit systems in exchange for appropriate payment. The tickets can be provided by any suitable ticket purchasing system, such as ticket purchasing system 100 (FIGS. 1A and 1B). At step 404, the tickets are activated prior to the users taking corresponding rides on any of the transportation platforms. The tickets can be activated by any suitable ticket activation system, such as ticket activation system 200 (FIGS. 1A and 1C). Activating the tickets generates event data representing the tickets and the corresponding rides. Steps 402 and 404 can also result in generating event data related to the use of transportation platforms that do not require tickets, such as a vehicle rideshare network or a vehicle share network. Thus, event data representing transportation events is generated for such use of transportation platforms that do not require tickets.

At step 406, the event data representing the transportation events (e.g., activated tickets and the corresponding rides, vehicle rideshare uses, vehicle share uses, etc.) is transmitted to a transportation platform compliant entry selection system, such as transportation platform compliant entry selection system 300. The data can be transmitted and received using any suitable mechanism or method, including those described herein in relation to transportation platform compliance system 10. At step 408, transportation platform compliant entries are stored in one or more memory devices of the transportation platform compliant entry selection system. In some implementations, the data transmitted to the transportation platform compliant entry selection system can be stored directly as the transportation platform compliant entries. In other implementations, the transportation platform compliant entry selection system analyzes the data to create the transportation platform compliant entries. In some implementations, each transportation platform compliant entry and its associated transportation event can be associated with a single user and a single transportation platform. In other implementations, a transportation platform compliant entry and its associated transportation event may be associated with one or more rides taken by one or more users on one or more transportation platforms. Further, each transportation platform compliant entry has a unique identifier that linked to the corresponding user(s).

At step 410, one of the transportation platform compliant entries is randomly selected. The random selection can be based generally upon any suitable random selection algorithm, including those discussed herein in connection with the transportation platform compliant entry selection system 300. Finally, at step 412, the unique identifier linked to the randomly selected transportation platform compliant entry is transmitted to a notification system (such as notification system 400) so that the transit system user associated with the randomly selected transportation platform compliant entry can be identified and/or announced.

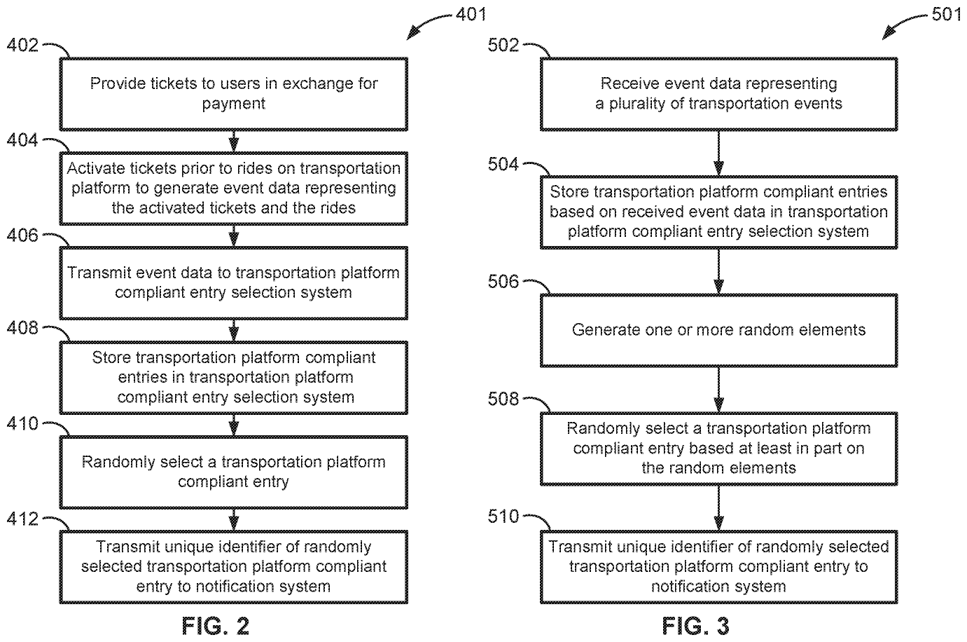

Referring now to FIG. 3, a method 501 (which is computer-implemented in some implementations) for controlling and increasing user compliance with transportation platform requirements is illustrated. At step 502, a selection system (such as transportation platform compliant entry selection system 300) receives event data representing a plurality of transportation events. Each transportation event is generally associated with one or more transportation platforms, and one or more users. The transportation events can be one or more rides on one or more transit systems using one or more activated tickets. The transportation events can also include a threshold amount of money or fares spent on one or more transportation platforms. The data is received via communication interface. At step 504, corresponding transportation platform compliant entries are stored in a memory device of the selection system. Each transportation platform compliant entry represents a single transportation event. The transportation platform compliant entries are based on the received data. In some implementations, the data that is received is stored directly as the transportation platform compliant entries. In other implementations, the data must be analyzed by the selection system in order to generate the individual entries, which are then stored. Each transportation platform compliant entry includes a unique identifier that is linked to the user that is associated with the entry (e.g., the user who experienced the transportation event that is associated with the entry).

At step 506, the selection system generates one or more random elements. The selection system can generally include a random element generator (such as a pseudo-random number generator or a hardware random number generator) that generates random elements (such as numbers, letters, symbols, etc.). At step 508, the selection system randomly selects one of the transportation platform compliant entries based at least in part on the random element. Finally, at step 510, the selection system transmits selection data to a notification system, which can identify the user associated with the randomly selected transportation platform compliant entry and/or announce the identity of the user. The selection data is generally representative of the unique identifier linked to the user associated with the randomly selected transportation platform compliant entry.

In some implementations, the system 10 or subsystems 100, 200, 300, 400 are implemented using only electronic tickets of electronic fare media (e.g., electronic fares associated with mobile tickets, smart cards, contactless EMV (Europay, Mastercard, and Visa) bankcards, NFC systems, mobile wallets, etc.). Thus, the data packets 302A, 302B . . . 302n send data to the transportation platform compliant entry selection system 300 that is related only to transit fare compliant rides using activated electronic tickets. In this manner, only users that use electronic tickets (e.g. tickets on a mobile phone, tablet, smartcard, NFC-enabled card, contactless card such as an EMV bankcard, mobile wallets. etc.) are linked to transportation platform compliant entries that are stored in the transportation platform compliant entry selection system 300. In some instances, it can be difficult to generate and store transportation platform compliant entries linked to rides taken using paper/physical tickets, because it can be difficult to generate unique and/or secure electronic data from these paper/physical tickets.

### Alternative Implementations

Alternative Implementation 1. According to some aspects, a transportation platform compliance system for controlling and increasing user compliance with transportation platform requirements comprises a communication interface, one or more memory devices, a random element generator, and one or more processing devices. The communication interface is configured to receive event data representing a plurality of transportation events. Each of the plurality of transportation events is associated with one of one or more transportation platforms and one of a plurality of users. The one or more memory devices are configured to store a plurality of transportation platform compliant entries based on the received data. Each respective transportation platform compliant entry represents a single one of the plurality of transportation events and includes a unique identifier linked to the associated one of the plurality of users. The random element generator is configured to generate one or more random elements. The one or more processing devices are configured to randomly select one of the plurality of transportation platform compliant entries based at least in part on the one or more random elements. The communication interface is further configured to transmit selection data representative of the unique identifier of the randomly selected transportation platform compliant entry for receipt by a notification system, thereby allowing the associated one of the plurality of users linked to the unique identifier of the randomly selected transportation platform compliant entry to be (i) identified, (ii) announced, or (iii) both (i) and (ii).

Alternative Implementation 2. The transportation platform compliance system of Alternative Implementation 1, wherein of the plurality of transportation events is a threshold number of rides on one of the plurality of transportation platforms, or a threshold fare amount for one or more rides on one of the plurality of transportation platforms.

Alternative Implementation 3. The transportation platform compliance system of Alternative Implementation 2, wherein the threshold number of rides is one ride.

Alternative Implementation 4. The transportation platform compliance system of any one of Alternative Implementations 1 to 3, wherein the random element generator is a pseudo-random number generator.

Alternative Implementation 5. The transportation platform compliance system of any one of Alternative Implementations 1 to 4, wherein the random element generator is a physical random number generator.

Alternative Implementation 6. The transportation platform compliance system of any one of Alternative Implementations 1 to 5, wherein the event data related to each single transportation event is stored as the respective transportation platform compliant entry corresponding to that single transportation event.

Alternative Implementation 7. The transportation platform compliance system of any one of Alternative Implementations 1 to 6, wherein the one or more processing devices are further configured to analyze the received event data and generate the plurality of transportation platform compliant entries based on the analysis of the received event data.

Alternative Implementation 8. The transportation platform compliance system of Alternative Implementation 7, wherein each transportation event has one or more characteristics, and wherein the one or more processing devices are configured to generate each of the plurality of transportation platform compliant entries as a combination of (i) the unique identifier linked to the associated one of the plurality of users, and (ii) a value of at least one of the one or more characteristics of the associated transportation event.

Alternative Implementation 9. The transportation platform compliance system of Alternative Implementation 8, wherein the random selection performed by the one or more processing devices is based at least in part on the values of at least one of the one or more characteristics.

Alternative Implementation 10. The transportation platform compliance system of Alternative Implementation 8 or Alternative Implementation 9, wherein the one or more characteristics of each transportation event includes: (i) a type of transportation platform associated with the transportation event, (ii) a type of ticket associated with the transportation event, (iii) a type of payment associated with the transportation event, (iv) an identity of a route associated with the transportation event, (v) a time of day the transportation event occurred, (vi) a distance traveled associated with the transportation event, (vii) a temporal duration of the transportation event, (viii) an age of the one of the plurality of users associated with the transportation event, (ix) a physical status of the one of the plurality of users associated with the transportation event, or (x) any combination of (i)-(ix).

Alternative Implementation 11. The transportation platform compliance system of Alternative Implementation 9 or Alternative Implementation 10, wherein the one or more processors are configured to generate multiple transportation platform compliant entries for a transportation event having a predetermined value of at least one of the one or more characteristics.

Alternative Implementation 12. The transportation platform compliance system of any one of Alternative Implementations 8 to 11, wherein a first transportation platform compliant entry corresponding to a first transportation event having a predetermined value of at least one of the one or more characteristics has an increased probability of being randomly selected by the transportation compliant entry selection system as compared to a second transportation platform compliant entry corresponding to a second transportation event not having the predetermined value of the at least one of the one or more characteristics.

Alternative Implementation 13. The transportation platform compliance system of any one of Alternative Implementations 8 to 12, wherein the one or more processors are further configured to (i) identify one or more transportation platform compliant entries not having a predetermined value of one of the one or more characteristics, (ii) discard one or more of the identified transportation platform compliant entries, and (iii) randomly select the one of the plurality of transportation platform compliant entries from the remaining non-discarded ones of the plurality of transportation platform compliant entries.

Alternative Implementation 14. The transportation platform compliance system of Alternative Implementation 13, wherein the one or more processors are configured to discard all of the identified transportation platform compliant entries, such that the randomly selected one of the plurality of transportation platform compliant entries is selected from only transportation platform compliant entries having a predetermined value of the one of the one or more characteristics.

Alternative Implementation 15. The transportation platform compliance system of any one of Alternative Implementations 8 to 14, wherein the one of the one or more characteristics of each transportation event is an age of the one of the plurality of users associated with the transportation event, and the value of the one of the one or more characteristics is a child, a non-senior adult, a student, or a senior citizen

Alternative Implementation 16. The transportation platform compliance system of Alternative Implementation 7 wherein each transportation event has one or more characteristics, and wherein the one or more processing devices are configured to generate a transportation platform compliant entry only for each of the plurality of transportation events having a predetermined value of the one of the one or more characteristics.

Alternative Implementation 17. The transportation platform compliance system of any one of Alternative Implementations 1 to 16, wherein the received event data includes data representing activations of one or more single-ride tickets, one or more multi-ride tickets, and one or more unlimited-use passes, and wherein the one or more processors are configured to determine a first number of transportation platform compliant entries to be generated from the activations of the one or more single-ride tickets, a second number of transportation platform compliant entries to be generated from the activations of the one or more multi-ride tickets, and a third number of transportation platform compliant entries to be generated from the activations of the one or more unlimited-use passes.

Alternative Implementation 18. The transportation platform compliance system of any one of Alternative Implementations 1 to 17, wherein the one or more transportation platforms includes a bus network, a subway network, a train network, a trolley network, a tram network, a ferry network, a motor vehicle rideshare network, a non-motor vehicle rideshare network, a motor vehicle share network, a non-motor vehicle share network, or any combination thereof.

Alternative Implementation 19. The transportation platform compliance system of Alternative Implementation 18, wherein the motor vehicle share network includes an automobile share network, motorized bicycle share network, a motorized scooter share network, a motorized personal transportation device share network, or any combination thereof.

Alternative Implementation 20. The transportation platform compliance system of Alternative Implementation 18 or Alternative Implementation 19, wherein the non-motor vehicle share network includes a non-motorized bicycle-share network, a non-motorized scooter-share network, or both.

Alternative Implementation 21. The transportation platform compliance system of any one of Alternative Implementations 1 to 20, wherein the unique identifier is (i) an ID number, (ii) a passcode, (iii) a phone number, (iv) a nickname, (v) an alias, (vi) an email address, (vii) a username, (viii) a residential address, (ix) a mailing address, or (x) any combination of (i)-(ix).

Alternative Implementation 22. The transportation platform compliance system of any one of Alternative Implementations 1 to 21, wherein the received event data includes data representative of at least one ticket activated for a ride on one of the one or more transportation platforms by one of the plurality of users, the at least one ticket being activated via a mobile device of the one of the plurality of users.

Alternative Implementation 23. A computer-implemented method for controlling and increasing user compliance with transportation platform requirements comprises receiving event data via a communication interface; a plurality of transportation platform compliant entries in one or more memory devices; generating one or more random elements via a random element generator; randomly selecting one of the plurality of transportation platform compliant entries based on the random elements; and transmitting selection data representative of a unique identifier of the randomly selected transportation platform compliant entry, via a communication interface. The event data represents a plurality of transportation events. Each of the plurality of transportation events is associated with one of one or more transportation platforms and one of a plurality of users. The transportation platform compliant entries are based on the received event data. Each respective transportation platform compliant entry represents a single one of the plurality of transportation events and includes a unique identifier linked to the associated one of the plurality of users. The selection data is transmitted for receipt by a notification system, thereby allowing the associated one of the plurality of users linked to the unique identifier of the randomly selected transportation platform compliant entry to be (i) identified, (ii) announced, or (iii) both (i) and (ii).

Alternative Implementation 24. The method of Alternative Implementation 20, wherein each of the plurality of transportation events is a threshold number of rides on one of the plurality of transportation platforms, or a threshold fare amount for one or more rides on one of the plurality of transportation platforms.

Alternative Implementation 25. The method of Alternative Implementation 24, wherein the threshold number of rides is one ride.

Alternative Implementation 26. The method of any one of Alternative Implementations 23 to 25, wherein the random element generator is a pseudo-random number generator.

Alternative Implementation 27. The method of any one of Alternative Implementations 23 to 25, wherein the random element generator is a physical random number generator.

Alternative Implementation 28. The method of any one of Alternative Implementations 23 to 27, wherein the event data related to each single transportation event is stored as the respective transportation platform compliant entry corresponding to that single transportation event.

Alternative Implementation 29. The method of any one of Alternative Implementations 23 to 28, further comprising: analyzing the received event data; and generating the plurality of transportation platform compliant entries based on the analysis of the received event data.

Alternative Implementation 30. The method of Alternative Implementation 29, wherein each transportation event has one or more characteristics, and wherein the method further comprises generating, via the one or more processing devices, each of the plurality of transportation platform compliant entries as a combination of (i) the unique identifier linked to the associated one of the plurality of users, and (ii) a value of at least one of the one or more characteristics of the associated transportation event.

Alternative Implementation 31. The method of Alternative Implementation 30, wherein the randomly selecting the one of the plurality of transportation platform compliant entries is based at least in part on the values of at least one of the one or more characteristics.

Alternative Implementation 32. The method of Alternative Implementation 30 or Alternative Implementation 31, wherein the one or more characteristics of each transportation event includes: (i) a type of transportation platform associated with the transportation event, (ii) a type of ticket associated with the transportation event, (iii) a type of payment associated with the transportation event, (iv) an identity of a route associated with the transportation event, (v) a time of day the transportation event occurred, (vi) a distance traveled associated with the transportation event, (vii) a temporal duration of the transportation event, (viii) an age of the one of the plurality of users associated with the transportation event, (ix) a physical status of the one of the plurality of users associated with the transportation event, or (x) any combination of (i)-(ix).

Alternative Implementation 33. The method of Alternative Implementation 31 or Alternative Implementation 32, further comprising generating, via the one or more processors, multiple transportation platform compliant entries for a transportation event having a predetermined value of at least one of the one or more characteristics.

Alternative Implementation 34. The method of any one of Alternative Implementations 30 to 33, wherein a first transportation platform compliant entry corresponding to a first transportation event having a predetermined value of at least one of the one or more characteristics has an increased probability of being randomly selected by the transportation compliant entry selection system as compared to a second transportation platform compliant entry corresponding to a second transportation event not having the predetermined value of the at least one of the one or more characteristics.

Alternative Implementation 35. The method of any one of Alternative Implementations 30 to 34, further comprising: (i) identifying, via the one or more processors, one or more transportation platform compliant entries not having a predetermined value of one of the one or more characteristics; (ii) discarding, via the one or more processors, one or more of the identified transportation platform compliant entries; and (iii) randomly selecting, via the one or more processors, the one of the plurality of transportation platform compliant entries from the remaining non-discarded ones of the plurality of transportation platform compliant entries.

Alternative Implementation 36. The method of Alternative Implementation 35, further comprising discarding, via the one or more processors, all of the identified transportation platform compliant entries, such that the randomly selected one of the plurality of transportation platform compliant entries is selected from only transportation platform compliant entries having a predetermined value of the one of the one or more characteristics.

Alternative Implementation 37. The method of any one of Alternative Implementations 30 to 36, wherein the one of the one or more characteristics of each transportation event is an age of the one of the plurality of users associated with the transportation event, and the value of the one of the one or more characteristics is a child, a non-senior adult, a student, or a senior citizen

Alternative Implementation 38. The method of Alternative Implementation 29 wherein each transportation event has one or more characteristics, and wherein the one or more processing devices are configured to generate a transportation platform compliant entry only for each of the plurality of transportation events having a predetermined value of the one of the one or more characteristics.

Alternative Implementation 39. The method of any one of Alternative Implementations 29 to 38, wherein the received event data includes data representing activations of one or more single-ride tickets, one or more multi-ride tickets, and one or more unlimited-use passes, and wherein the method further comprises determining, via the one or more processors, a first number of transportation platform compliant entries to be generated from the activations of the one or more single-ride tickets, a second number of transportation platform compliant entries to be generated from the activations of the one or more multi-ride tickets, and a third number of transportation platform compliant entries to be generated from the activations of the one or more unlimited-use passes.

Alternative Implementation 40. The method of any one of Alternative Implementations 23 to 39, wherein the one or more transportation platforms includes a bus network, a subway network, a train network, a trolley network, a tram network, a ferry network, a motor vehicle rideshare network, a non-motor vehicle rideshare network, a motor vehicle share network, a non-motor vehicle share network, or any combination thereof.

Alternative Implementation 41. The method of Alternative Implementation 40, wherein the motor vehicle share network includes an automobile share network, motorized bicycle share network, a motorized scooter share network, a motorized personal transportation device share network, or any combination thereof.

Alternative Implementation 42. The method of Alternative Implementation 40 or Alternative Implementation 41, wherein the non-motor vehicle share network includes a non-motorized bicycle-share network, a non-motorized scooter-share network, or both.

Alternative Implementation 43. The method of any one of Alternative Implementations 23 to 42, wherein the unique identifier is (i) an ID number, (ii) a passcode, (iii) a phone number, (iv) a nickname, (v) an alias, (vi) an email address, (vii) a username, (viii) a residential address, (ix) a mailing address, or (x) any combination of (i)-(ix).

Alternative Implementation 44. The method of any one of Alternative Implementations 23 to 43, wherein the received event data includes data representative of at least one ticket activated for a ride on one of the one or more transportation platforms by one of the plurality of users, the at least one ticket being activated via a mobile device of the one of the plurality of users.

Alternative Implementation 45. A transportation platform compliance system for controlling and increasing user compliance with transportation platform requirements comprises a fare purchasing system, a ticket activation system, and a transportation platform compliant entry selection system. The fare purchasing system is configured to provide tickets to a plurality of users. Each ticket is provided in response to receiving input data representing a corresponding validated payment. The ticket activation system is configured to activate each of the provided tickets prior to corresponding rides on one of one or more transportation platforms by the plurality of users. The ticket activation system is further configured to generate data representing the activated tickets and the corresponding rides. The transportation platform compliant entry selection system is configured to (i) receive, from the ticket activation system, at least a portion of the generated data representing the activated tickets and the corresponding rides, and (ii) store a plurality of transportation platform compliant entries based on the received data. Each respective transportation platform compliant entry corresponds to a single ride by one of the plurality of users on the one of the one or more transportation platforms using one of the activated tickets. Each respective transportation platform compliant entry includes a unique identifier linked to a corresponding one of the plurality of users. The transportation platform compliant entry selection system is configured to randomly select one of the plurality of transportation platform compliant entries and transmit selection data representative of the unique identifier of the randomly selected transportation platform compliant entry for receipt by a notification system, thereby allowing the corresponding one of the plurality of users associated with the unique identifier of the randomly selected transportation platform compliant entry to be (i) identified, (ii) announced, or (iii) both (i) and (ii).

Alternative Implementation 46. The transportation platform compliance system of Alternative Implementation 45, wherein the one or more transportation platforms includes bus network, a subway network, a train network, a trolley network, a tram network, a motor vehicle rideshare network, a non-motor vehicle rideshare network, a motor vehicle share network, a non-motor vehicle share network, or any combination thereof.

Alternative Implementation 47. The transportation platform compliance system of Alternative Implementations 45 or 46, wherein the transportation platform compliant entry selection system includes a processing device, a communication interface, and one or more memory devices.

Alternative Implementation 48. The transportation platform compliance system of Alternative Implementation 47, wherein the transportation platform compliant entry selection system is configured to receive the generated data from the ticket activation system via the communication interface and store the plurality of transportation platform compliant entries in the one or more memory devices.

Alternative Implementation 49. The transportation platform compliance system of Alternative Implementation 48, wherein the processing device is configured to randomly select one of the plurality of transportation platform compliant entries and to transmit the unique identifier of the randomly selected one of the plurality of transportation platform compliant entries via the communication interface.

Alternative Implementation 50. The transportation platform compliance system of any one of Alternative Implementations 45 to 49, wherein each ride taken by one of the plurality of users has one or more characteristics, and wherein the random selection performed by the transportation platform compliant entry selection system is weighted according to data values representing the one or more characteristics.

Alternative Implementation 51. The transportation platform compliance system of Alternative Implementation 50, wherein the one or more characteristics of each ride includes: (i) a type of transportation platform associated with the ride, (ii) a type of ticket associated with the ride, (iii) a type of payment associated with the ride, (iv) an identity of a route associated with the ride, (v) a time of day the ride occurred, (vi) a distance traveled associated with the ride, (vii) a temporal duration of the ride, (viii) an age of the one of the plurality of users associated with the ride, (ix) a physical status of the one of the plurality of users associated with the ride, or (x) any combination of (i)-(ix).

Alternative Implementation 52. The transportation platform compliance system of Alternative Implementation 50 or Alternative Implementation 51, wherein the transportation platform compliant entry selection system is configured to generate multiple transportation platform compliant entries for a ride having a predetermined value of at least one of the one or more characteristics.

Alternative Implementation 53. The transportation platform compliance system of any one of Alternative Implementations 50 to 52, wherein a first transportation platform compliant entry corresponding to a first ride having a predetermined value of at least one of the one or more characteristics has an increased probability of being randomly selected by the transportation platform compliant entry selection system as compared to a second transportation platform compliant entry corresponding to a second ride not having the predetermined value of the at least one of the one or more characteristics.

Alternative Implementation 54. The transportation platform compliance system of any one of Alternative Implementations 45 to 53, wherein the ticket activation system includes one or more ticket readers configured to read tickets to thereby activate the tickets and to generate the data related to the activated tickets.

Alternative Implementation 55. The transportation platform compliance system of any one of Alternative Implementations 45 to 54, wherein each of the one or more ticket readers includes a communication interface to transmit at least a portion of the generated data identifying a transportation platform compliant entry to the transportation platform compliant entry selection system or to a main hub of the ticket activation system.

Alternative Implementation 56. The transportation platform compliance system of any one of Alternative Implementations 45 to 55, wherein a first one of the one or more ticket readers is positioned on a bus, and wherein a second one of the one or more ticket readers is positioned in a subway system.

Alternative Implementation 57. The transportation platform compliance system of any one of Alternative Implementations 45 to 56, wherein the unique identifier of each transportation platform compliant entry is linked to a name of the corresponding one of the plurality of users.

Alternative Implementation 58. A computer-implemented method for increasing and controlling user compliance with transportation platform payment requirements comprises providing tickets to a plurality of users; activating each of the provided tickets prior to corresponding rides on one of one or more transportation platforms; transmitting at least a portion of the generated data related to the activated tickets and the corresponding rides; storing a plurality of transportation platform compliant entries based on the received data; randomly selecting one of the plurality of transportation platform compliant entries; transmitting selection data representing the unique identifier of the randomly selected transportation platform compliant entry; and announcing an identity of the corresponding one of the plurality of users associated with a unique identifier of the randomly selected transportation platform compliant entry. The tickets are provided via a computer-implemented ticket purchasing system. Each ticket is provided in response to receiving input data representing a corresponding payment. The provided tickets are activated via a computer-implemented ticket activation system. Activating the provided tickets generates data related to the activated tickets and the corresponding rides. The generated data is transmitted via a first communication interface to a transportation platform compliant entry selection system. The transportation platform compliant entries are stored in a memory of the transportation platform compliant entry selection system. Each respective transportation platform compliant entry corresponds to a single ride by one of the plurality of users on the one of the one or more transportation platform using one of the activated tickets. Each respective transportation platform compliant entry includes a unique identifier linked to a corresponding one of the plurality of users. The selection data is transmitted via the first communication interface or a second communication interface to a notification system. The identity of the corresponding one of the plurality of users is announced via the notification system.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

While various implementations of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described implementations. Rather, the scope of the invention should be defined in accordance with the following claims and their equivalents.

What is claimed is:

1. A transportation platform compliance system for controlling and increasing user compliance with transportation platform requirements, the transportation platform compliance system comprising:
a communication interface configured to receive event data representing a plurality of transportation events, each of the plurality of transportation events being associated with one of one or more transportation platforms and one of a plurality of users;
one or more memory devices configured to store a plurality of transportation platform compliant entries based on the received data, each respective transportation platform compliant entry representing a single one of the plurality of transportation events and including a unique identifier linked to the associated one of the plurality of users;
a random element generator configured to generate one or more random elements; and
one or more processing devices configured to randomly select one of the plurality of transportation platform compliant entries based at least in part on the one or more random elements,
wherein the communication interface is further configured to transmit selection data representative of the unique identifier of the randomly selected transportation platform compliant entry for receipt by a notification system, thereby allowing the associated one of the plurality of users linked to the unique identifier of the randomly selected transportation platform compliant entry to be (i) identified, (ii) announced, or (iii) both (i) and (ii).

2. The transportation platform compliance system of claim 1, wherein each of the plurality of transportation events is a threshold number of rides on one of the plurality of transportation platforms, or a threshold fare amount for one or more rides on one of the plurality of transportation platforms.

3. The transportation platform compliance system of claim 1, wherein the one or more processing devices are further configured to analyze the received event data and generate the plurality of transportation platform compliant entries based on the analysis of the received event data.

4. The transportation platform compliance system of claim 3, wherein each transportation event has one or more characteristics, and wherein the one or more processing devices are configured to generate each of the plurality of transportation platform compliant entries as a combination of (i) the unique identifier linked to the associated one of the plurality of users, and (ii) a value of at least one of the one or more characteristics of the associated transportation event.

5. The transportation platform compliance system of claim 4, wherein the random selection performed by the one or more processing devices is based at least in part on the values of at least one of the one or more characteristics.

6. The transportation platform compliance system of claim 4, wherein the one or more characteristics of each transportation event includes: (i) a type of transportation platform associated with the transportation event, (ii) a type of ticket associated with the transportation event, (iii) a type of payment associated with the transportation event, (iv) an identity of a route associated with the transportation event, (v) a time of day the transportation event occurred, (vi) a distance traveled associated with the transportation event, (vii) a temporal duration of the transportation event, (viii) an age of the one of the plurality of users associated with the transportation event, (ix) a physical status of the one of the plurality of users associated with the transportation event, or (x) any combination of (i)-(ix).

7. The transportation platform compliance system of claim 5, wherein the one or more processors are configured to generate multiple transportation platform compliant entries for a transportation event having a predetermined value of at least one of the one or more characteristics.

8. The transportation platform compliance system of claim 5, wherein a first transportation platform compliant entry corresponding to a first transportation event having a predetermined value of at least one of the one or more characteristics has an increased probability of being randomly selected by the transportation compliant entry selection system as compared to a second transportation platform compliant entry corresponding to a second transportation event not having the predetermined value of the at least one of the one or more characteristics.

9. The transportation platform compliance system of claim 5, wherein the one or more processors are further configured to (i) identify one or more transportation platform compliant entries not having a predetermined value of one of the one or more characteristics, (ii) discard one or more of the identified transportation platform compliant entries, and (iii) randomly select the one of the plurality of transportation platform compliant entries from the remaining non-discarded ones of the plurality of transportation platform compliant entries.

10. The transportation platform compliance system of claim 3 wherein each transportation event has one or more characteristics, and wherein the one or more processing devices are configured to generate a transportation platform compliant entry only for each of the plurality of transportation events having a predetermined value of the one of the one or more characteristics.

11. The transportation platform compliance system of claim 1, wherein the received event data includes data representing activations of one or more single-ride tickets, one or more multi-ride tickets, and one or more unlimited-use passes, and wherein the one or more processors are configured to determine a first number of transportation platform compliant entries to be generated from the activations of the one or more single-ride tickets, a second number of transportation platform compliant entries to be generated from the activations of the one or more multi-ride tickets, and a third number of transportation platform compliant entries to be generated from the activations of the one or more unlimited-use passes.

12. The transportation platform compliance system of claim 1, wherein the one or more transportation platforms includes a bus network, a subway network, a train network, a trolley network, a tram network, a ferry network, a motor vehicle rideshare network, a non-motor vehicle rideshare network, a motor vehicle share network, a non-motor vehicle share network, or any combination thereof.

13. The transportation platform compliance system of claim 1, wherein the unique identifier is (i) an ID number, (ii) a passcode, (iii) a phone number, (iv) a nickname, (v) an alias, (vi) an email address, (vii) a username, (viii) a residential address, (ix) a mailing address, or (x) any combination of (i)-(ix).

14. The transportation platform compliance system of claim 1, wherein the received event data includes data representative of at least one ticket activated for a ride on one of the one or more transportation platforms by one of the plurality of users, the at least one ticket being activated via a mobile device of the one of the plurality of users.

15. A computer-implemented method for controlling and increasing user compliance with transportation platform requirements, the method comprising:
receiving, via a communication interface, event data representing a plurality of transportation events, each of the plurality of transportation events being associated with one of one or more transportation platforms and one of a plurality of users;
storing, in one or more memory devices, a plurality of transportation platform compliant entries based on the received event data, each respective transportation platform compliant entry representing a single one of the plurality of transportation events and including a unique identifier linked to the associated one of the plurality of users;
generating, via a random element generator, one or more random elements;
randomly selecting one of the plurality of transportation platform compliant entries based at least in part on the one or more random elements; and
transmitting, via the communication interface, selection data representative of the unique identifier of the randomly selected transportation platform compliant entry for receipt by a notification system, thereby allowing the associated one of the plurality of users linked to the unique identifier of the randomly selected transportation platform compliant entry to be (i) identified, (ii) announced, or (iii) both (i) and (ii).

16. The method of claim 15, wherein each of the plurality of transportation events is a threshold number of rides on one of the plurality of transportation platforms, or a threshold fare amount for one or more rides on one of the plurality of transportation platforms.

17. The method of claim 15, further comprising:
analyzing the received event data; and
generating the plurality of transportation platform compliant entries based on the analysis of the received event data.

18. The method of claim 17, wherein each transportation event has one or more characteristics, and wherein the method further comprises generating, via the one or more processing devices, each of the plurality of transportation platform compliant entries as a combination of (i) the unique identifier linked to the associated one of the plurality of users, and (ii) a value of at least one of the one or more characteristics of the associated transportation event.

19. The method of claim 18, wherein the randomly selecting the one of the plurality of transportation platform compliant entries is based at least in part on the values of at least one of the one or more characteristics.

20. The method of claim 18, wherein the one or more characteristics of each transportation event includes: (i) a type of transportation platform associated with the transportation event, (ii) a type of ticket associated with the transportation event, (iii) a type of payment associated with the transportation event, (iv) an identity of a route associated with the transportation event, (v) a time of day the transportation event occurred, (vi) a distance traveled associated with the transportation event, (vii) a temporal duration of the transportation event, (viii) an age of the one of the plurality of users associated with the transportation event, (ix) a physical status of the one of the plurality of users associated with the transportation event, or (x) any combination of (i)-(ix).

21. The method of claim 19, further comprising generating, via the one or more processors, multiple transportation platform compliant entries for a transportation event having a predetermined value of at least one of the one or more characteristics.

22. The method of claim 19, wherein a first transportation platform compliant entry corresponding to a first transportation event having a predetermined value of at least one of the one or more characteristics has an increased probability of being randomly selected by the transportation compliant entry selection system as compared to a second transportation platform compliant entry corresponding to a second transportation event not having the predetermined value of the at least one of the one or more characteristics.

23. The method of claim 19, further comprising:
(i) identifying, via the one or more processors, one or more transportation platform compliant entries not having a predetermined value of one of the one or more characteristics;
(ii) discarding, via the one or more processors, one or more of the identified transportation platform compliant entries; and
(iii) randomly selecting, via the one or more processors, the one of the plurality of transportation platform compliant entries from the remaining non-discarded ones of the plurality of transportation platform compliant entries.

24. The method of claim 17 wherein each transportation event has one or more characteristics, and wherein the one or more processing devices are configured to generate a transportation platform compliant entry only for each of the plurality of transportation events having a predetermined value of the one of the one or more characteristics.

25. The method of claim 15, wherein the received event data includes data representing activations of one or more single-ride tickets, one or more multi-ride tickets, and one or more unlimited-use passes, and wherein the method further comprises determining, via the one or more processors, a first number of transportation platform compliant entries to be generated from the activations of the one or more single-ride tickets, a second number of transportation platform compliant entries to be generated from the activations of the one or more multi-ride tickets, and a third number of transportation platform compliant entries to be generated from the activations of the one or more unlimited-use passes.

26. The method of claim 15, wherein the one or more transportation platforms includes a bus network, a subway network, a train network, a trolley network, a tram network, a ferry network, a motor vehicle rideshare network, a non-motor vehicle rideshare network, a motor vehicle share network, a non-motor vehicle share network, or any combination thereof.

27. The method of claim 15, wherein the unique identifier is (i) an ID number, (ii) a passcode, (iii) a phone number, (iv) a nickname, (v) an alias, (vi) an email address, (vii) a username, (viii) a residential address, (ix) a mailing address, or (x) any combination of (i)-(ix).

28. The method of claim 15, wherein the received event data includes data representative of at least one ticket activated for a ride on one of the one or more transportation platforms by one of the plurality of users, the at least one ticket being activated via a mobile device of the one of the plurality of users.

29. A transportation platform compliance system for controlling and increasing user compliance with transportation platform requirements, the transportation platform compliance system comprising:
a fare purchasing system configured to provide tickets to a plurality of users, each ticket provided in response to receiving input data representing a corresponding validated payment;
a ticket activation system configured to activate each of the provided tickets prior to corresponding rides on one of one or more transportation platforms by the plurality of users, the ticket activation system further being configured to generate data representing the activated tickets and the corresponding rides; and
a transportation platform compliant entry selection system configured to (i) receive, from the ticket activation system, at least a portion of the generated data representing the activated tickets and the corresponding rides, and (ii) store a plurality of transportation platform compliant entries based on the received data, each respective transportation platform compliant entry corresponding to a single ride by one of the plurality of users on the one of the one or more transportation platforms using one of the activated tickets, each respective transportation platform compliant entry including a unique identifier linked to a corresponding one of the plurality of users, the transportation platform compliant entry selection system being configured to randomly select one of the plurality of transportation platform compliant entries and transmit selection data representative of the unique identifier of the randomly selected transportation platform compliant entry for receipt by a notification system, thereby allowing the corresponding one of the plurality of users associated with the unique identifier of the randomly selected transportation platform compliant entry to be (i) identified, (ii) announced, or (iii) both (i) and (ii).

30. A computer-implemented method for increasing and controlling user compliance with transportation platform payment requirements, the method comprising:
providing, via a computer-implemented ticket purchasing system, tickets to a plurality of users, each ticket being provided in response to receiving input data representing a corresponding payment;
activating, via a computer-implemented ticket activation system, each of the provided tickets prior to corresponding rides on one of one or more transportation platforms to generate data related to the activated tickets and the corresponding rides;
transmitting, via a first communication interface, at least a portion of the generated data related to the activated tickets and the corresponding rides to a transportation platform compliant entry selection system;
storing, in a memory of the transportation platform compliant entry selection system, a plurality of transportation platform compliant entries based on the received data, each respective transportation platform compliant entry corresponding to a single ride by one of the plurality of users on the one of the one or more transportation platform using one of the activated tickets, each respective transportation platform compliant entry including a unique identifier linked to a corresponding one of the plurality of users;
randomly selecting one of the plurality of transportation platform compliant entries;
transmitting, via the first communication interface or a second communication interface, selection data representing the unique identifier of the randomly selected transportation platform compliant entry to a notification system; and
announcing, via the notification system, an identity of the corresponding one of the plurality of users associated with the unique identifier of the randomly selected transportation platform compliant entry.
